(19) United States
(12) Patent Application Publication
(10) Pub. No.: US 2020/0370583 A1
(43) Pub. Date: Nov. 26, 2020

(54) RELEASABLE ADHESIVE CONNECTION, AND METHOD FOR RELEASING THE ADHESIVE CONNECTION

(71) Applicant: AUDI AG, Ingolstadt (DE)

(72) Inventors: Carsten BÄR, Ingolstadt (DE); Alexander BECK, Ingolstadt (DE)

(73) Assignee: AUDI AG, Ingolstadt (DE)

(21) Appl. No.: 16/763,692

(22) PCT Filed: Nov. 5, 2018
(86) PCT No.: PCT/EP2018/080084

§ 371 Date: May 13, 2020

(30) Foreign Application Priority Data
Nov. 30, 2017 (DE) 10 2017 221 538.0

(51) Int. Cl. F16B 11/00; C09J 5/06

(52) U.S. Cl. CPC F16B 11/006; C09J 5/06

(57) ABSTRACT

A releasable adhesive connection between two joint partners, which are materially bonded to one another by means of an adhesive, wherein the adhesive connection is releasable in a separating process by an introduction of heat. According to the disclosure, the introduction of heat is performed using a heated thermofluid. A first joint partner comprises at least one fluid chamber, which is filled at least in the separating process using the thermofluid and which indirectly or directly adjoins the adhesive with a chamber wall, so that in the separating process, the introduction of heat into the adhesive takes place by means of heat conduction from the thermofluid via the chamber wall into the adhesive.

The invention relates to a releasable adhesive connection according to the preamble of claim 1 and a method for releasing the adhesive connection according to claim 11.

Components and assemblies can be structurally joined by adhesive connection on present vehicle bodies, both in the vehicle body region and also in the assembly region. These connections significantly contribute, both statically and also dynamically, to the strength and the rigidity of the vehicle body due to the mechanical performance capability thereof. Furthermore, they ensure the leak-tightness of the connections, thus, for example, as a corrosion protection and to avoid the penetration of water into the vehicle interior. This functionality is to be ensured over the entire vehicle lifetime. The challenge exists to an increasing extent of being able to release these adhesive connections without destroying adjoining components, for example, for repair purposes or for material-specific separation of various materials for efficient material recycling. One common procedure is, for example, the separation of vehicle plates by means of cutting wire or vibrating blade. The accessibility of the tool to the joint is to be ensured here in any case, down to a minimum gap of approximately 2.5 mm. Adhesive widths are typically 10 mm in this case. The adhesives used here are relatively soft, do not have high strengths, for example, shear moduli in the range of 1 to 4 MPa are typical.

New vehicle constructions are going over toward larger assemblies such as battery boxes being joined in the vehicle structure by means of adhesive connection, for example, by higher-modulus, structural adhesives, for example, on the basis of polyurethane, MS polymer, or silicone. The widths of the adhesive surfaces are substantially greater in this case than previously typical, for example, circumferentially up to 100 mm width. The shear moduli are provided in the range of 10 to 100 MPa. Such adhesive connections may no longer be mechanically separated using cutting blades or cutting wires because of the adhesive hardness thereof and the large area.

A generic releasable adhesive connection between two joint partners, which are materially bonded to one another by means of an adhesive, is known in a delimitation from such adhesive connections from DE 39 07 261 A1. The adhesive connection can be released in a separation process by an introduction of heat. For example, such an adhesive releasable by heat action can be a polyurethane adhesive, in which after heating to 220° C. with a holding time of 10 seconds, a complete release of the adhesive connection occurs, wherein the residual moisture is almost zero. This effect is irreversible, strength no longer builds up, even after cooling.

Especially in adhesive connections of very large and complex assemblies, the heat in the separation process has to be supplied locally, for example, without damaging other components. The release of the adhesive connections moreover has to be able to take place quickly, wherein the occurring process temperatures/holding times have to be well controllable. Therefore, a conventional release of the adhesive connection is linked to a high time expenditure and a high energy expenditure, which are disadvantageous in manufacturing.

The object of the invention is to provide an adhesive system, using which an adhesive connection is releasable with reduced time and energy expenditure in comparison to the prior art.

The object is achieved by the features of claim 1. Preferred refinements of the invention are disclosed in the dependent claims.

According to the characterizing part of claim 1, the introduction of heat to release the adhesive connection is performed by a heated thermofluid. According to the invention, the thermofluid does not come directly into contact with the adhesive. Rather, a first of the two joint partners comprises a fluid chamber, which is filled using the heated thermofluid at least during the separation process. A chamber wall defining the fluid chamber indirectly or directly adjoins the adhesive in this case. In the separation process, the introduction of heat into the adhesive is thus implemented by means of heat conduction from the first thermofluid via the chamber wall into the adhesive.

Especially upon the use of the invention in vehicle construction, the first joint partner can preferably be a multi-chamber extruded profile part, which is manufactured by way of example from an aluminum alloy, which is distinguished by a high heat conductivity. In this case, a chamber adjoining the adhesive connection of such an extruded profile part can be flooded and/or perfused using the correspondingly temperature-controlled thermofluid in a simple manner, until the adhesive connection is heated by means of heat conduction in such a way that it can readily be released. In contrast to the prior art, a local release of the adhesive connection is readily enabled using the invention.

In one technical implementation, the thermofluid can be a liquid which can be sufficiently heated, for example, to a required temperature of 220° C. By way of example, the thermofluid can be a mineral oil. It is advantageous to select the fluid temperature to be, for example, 10% higher than the required release temperature in order to achieve sufficiently rapid heating of the adhesive location, specifically in consideration of the temperature gradient in the chamber wall adjoining the adhesive location.

The holding time during the release has to be individually ascertained for the respective application, since a delay occurs due to the heat conduction. It is presumed that a release is enabled in the case of typical constructions and profile wall thicknesses within a few minutes (1 to 2 minutes). The temperature control of the thermofluid can take place in a tank, which can be heated, of a workshop device, i.e., outside the vehicle. The workshop device can moreover have a regulator and controller of the thermofluid temperature, a circulating pump, and hose fittings and hoses. Active suctioning off of thermofluid residues which are still located after the separation process in the hoses and the flooded fluid chamber of the extruded profile part is also provided.

Detachable couplings, for example, hose couplings, are to be provided in the construction of the fluid chamber of the extruded profile part, so that a simple connection of supply and return is enabled. For example, the hose couplings can be implemented as quick-action couplings.

Further aspects of the invention are described more extensively hereafter: As already indicated above, the first joint partner can be designed as a component conducting thermofluid and can be incorporated into a preferably closed heating circuit. In the heating circuit, the thermofluid can be introduced via a supply connecting part into the fluid chamber of the first joint partner and can be conducted out of the fluid chamber of the joint partner via a return connecting part. This is preferably performed under forced conduction by means of a flow unit, such as a circulating pump. In addition to the flow unit and the fluid chamber of the joint partner, a heating unit and a thermofluid reservoir can additionally be integrated into the heating circuit. The thermofluid reservoir is preferably a tank, which can be heated and in which the heating unit is installed.

The above-mentioned heating circuit can be divided in one preferred embodiment into a first partial circuit on the joint partner side and a second partial circuit, which can be decoupled from the joint partner. It is preferable if the second partial circuit can be fluidically decoupled in a simple manner from the first joint partner at the supply and return connecting parts. The flow unit, the heating unit, and the thermofluid reservoir can preferably be integrated into the second partial circuit, which can be decoupled. These components therefore do not have to be carried along continuously on the first joint partner, but rather only form an operational connection with the first joint partner when carrying out the separation process.

With respect to a perfect separation process, it is preferable if the flow unit, the heating unit, and supply and return temperature sensors are components of an electronic control loop, in which a regulating unit can automatically activate the heating unit and/or the flow unit during the separation process on the basis of the detected supply and/or return temperature. The regulating unit can be associated for this purpose with an input unit, by means of which a heating duration and/or a heating temperature of the thermofluid can be predetermined.

In one specific embodiment, the first joint partner can be installed as a body-side frame structure in an electrically operated vehicle. The frame structure can be constructed from longitudinal beams and crossbeams and can enclose a traction battery of the motor vehicle. The longitudinal beams and crossbeams can be brought into releasable adhesive connection with the traction battery in this case using the inner walls thereof. In one application of the invention, the longitudinal beams and crossbeams can each be embodied having closed hollow profiles, which can form a closed flow channel around the traction battery. Under certain circumstances, it can be advantageous to divide the flow channel into various sections, wherein then each section has to have a separate supply and drain.

A removal of the traction battery from the body-side frame structure can be carried out by means of the above-described separating process, in which the hollow profiles of the longitudinal beams and crossbeams of the frame profile are permeated using the heated thermofluid to release the adhesive connection between the traction battery and the frame structure.

An exemplary embodiment of the invention is described hereafter with the aid of the appended figures.

In the figures:

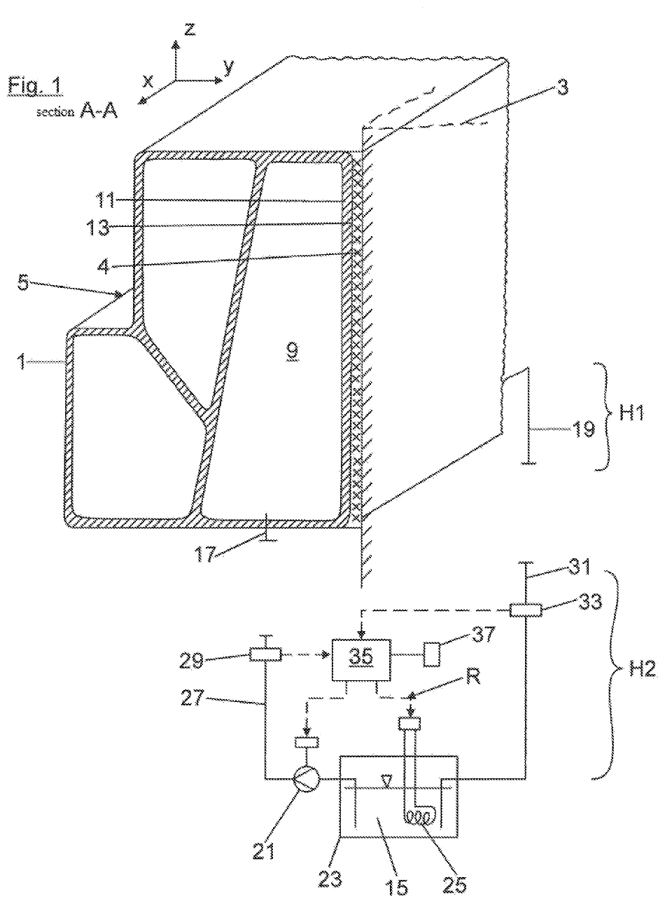

FIG. 1 shows an enlarged perspective illustration in partial section of an adhesive connection between a vehicle body longitudinal beam of an electrically operated vehicle and a traction battery of the vehicle and also a thermofluid partial circuit decoupled therefrom;

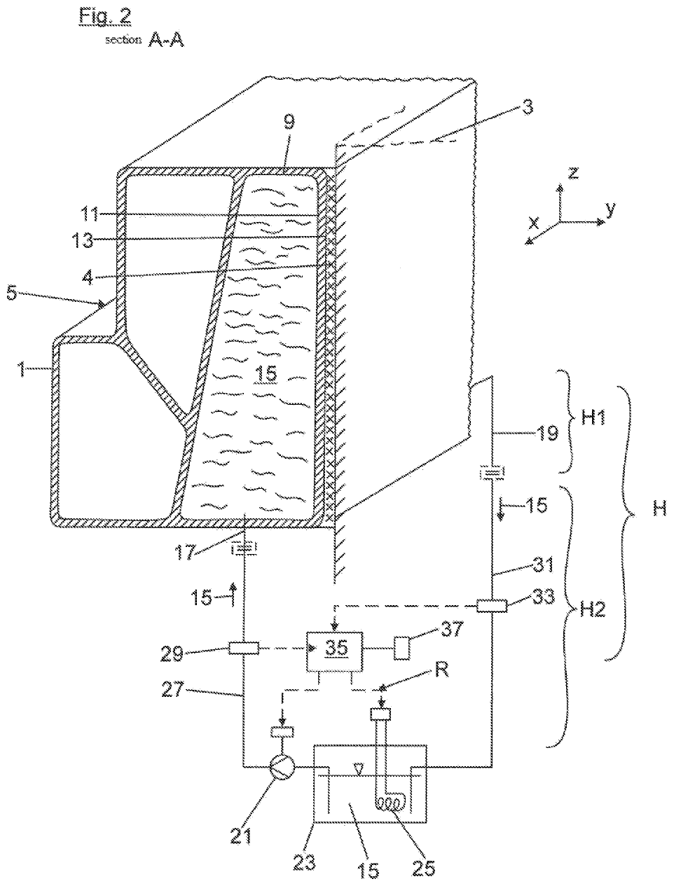

FIG. 2 shows a view corresponding to FIG. 1 having thermofluid partial circuit fluidically coupled on the vehicle body longitudinal beam;

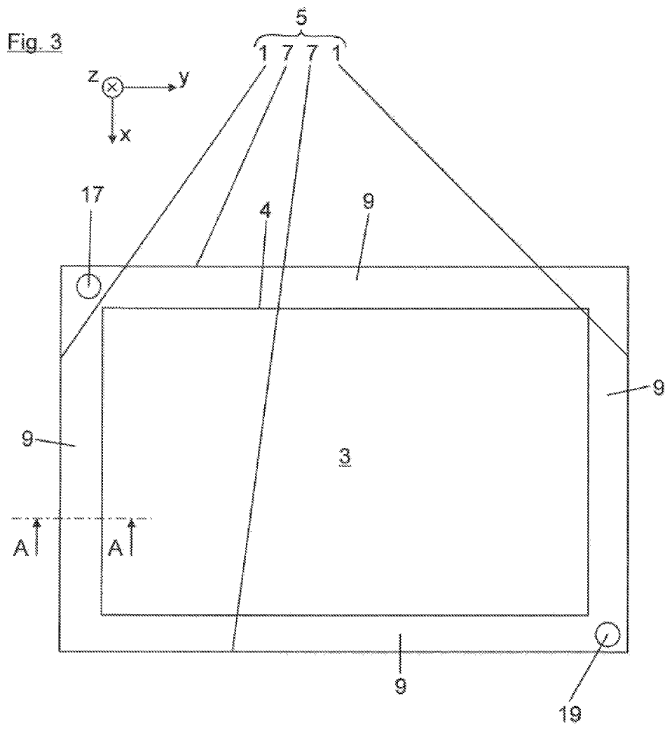

FIG. 3 shows a rough schematic illustration of a body-side frame structure having traction battery adhesively connected therein in a view from above; and

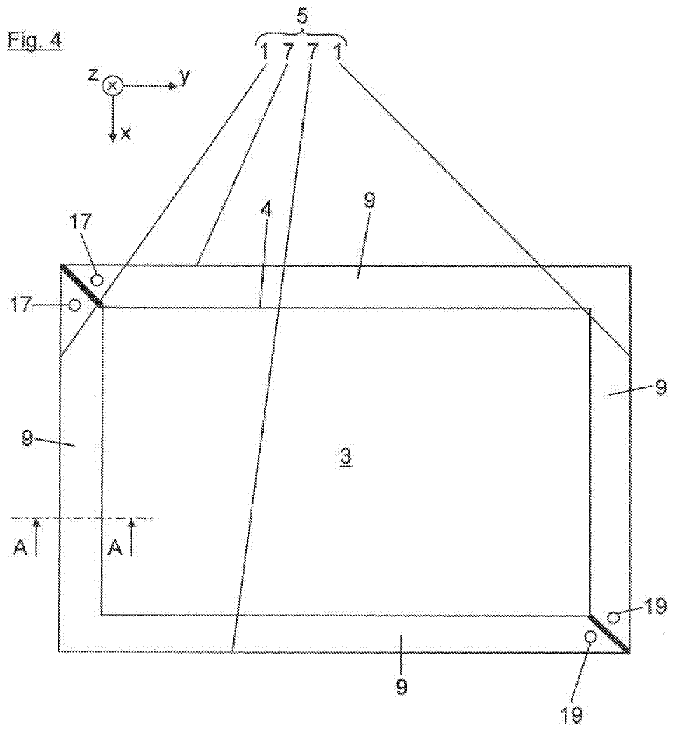

FIG. 4 shows a further exemplary embodiment in a view corresponding to FIG. 3.

A releasable adhesive connection is shown in FIG. 1, in which the vehicle body longitudinal beam 1 of an electrically operated vehicle (not shown in greater detail) is adhesively connected via an adhesive 4 to a traction battery 3 of the electrically operated vehicle. The vehicle body longitudinal beam 1 is part of a closed frame structure 5 shown in FIG. 3, in which the lateral vehicle body longitudinal beams 1 are connected to one another in the vehicle transverse direction y by means of front and rear crossbeams 7. The longitudinal beams and crossbeams 1, 7 are adhesively connected on the inner side via the adhesive 4 to the traction battery 3.

Both the longitudinal beams 1 and also the crossbeams 7 are formed by way of example from multi-chamber extruded profile parts, as shown by way of example in FIGS. 1 and 2 with the aid of one of the vehicle body longitudinal beams 1. As a result, a vehicle-interior chamber facing toward the traction battery 3 in the multi-chamber profile of the vehicle body longitudinal beam 1 forms a fluid chamber 9, which is delimited toward the vehicle interior via an inner chamber wall 11. The chamber wall 11 forms a contact surface 13 wetted using the adhesive 4 on its inner side in the vehicle transverse direction y. In the same manner, the further longitudinal beam 1 and also the two crossbeams 7 are implemented having such a fluid chamber 9, wherein all fluid chambers 9 of the longitudinal beams and crossbeams 1, 7 are terminated fluid-tight to the outside and are fluidically connected to one another.

In a separating process described later with the aid of FIG. 2, the fluid chambers 9 of the longitudinal beams and crossbeams 1, 7 are permeated by a heated thermofluid 15, with the aid of which an introduction of heat takes place by heat conduction via the inner chamber wall 11 into the adhesive 4 to release it.

As indicated by way of example in FIG. 2, the fluid chambers 9 of the longitudinal beams and crossbeams 1, 7 can be incorporated into a closed heating circuit H. In the heating circuit H, the thermofluid 15 is introduced via a supply connecting part 17 into the fluid chambers 9 of the frame structure 5 and conducted out of the fluid chambers 9 of the frame structure 5 via a return connecting part 19. As shown in FIG. 1 or 2, the heating circuit H comprises a circulating pump 21 and a thermofluid tank 23, in which a heating unit 25 is integrated. A supply temperature sensor 29 is arranged in a supply line 27, while a return temperature sensor 33 is arranged in a return line 31. Both the supply connecting part 17 and also the return connecting part 19 are implemented as quick-action couplings, on which the supply line 27 and the return line 31 can be readily coupled or decoupled. In this manner, the heating circuit H can be divided into a first vehicle-side partial circuit H1, which comprises the fluid chambers 9, and a second partial circuit H2, which comprises the circulating pump 21, the thermofluid tank 23, and the temperature sensors 29, 33 and can be decoupled from the vehicle.

The circulating pump 21, the heating unit 25 installed in the thermofluid tank 23, and the two supply and return temperature sensors 29, 33 are, in FIGS. 1 and 2, parts of an electronic control loop R, in which a regulating unit 35 has a signaling connection (shown by dashed lines) to the supply and return temperature sensors 29, 33 and to the heating unit 25 and the circulating pump 21. The regulating unit 35 is moreover associated in FIGS. 1 and 2 with an input unit 37, by means of which a heating duration and a heating temperature of the thermofluid 15 can be predetermined.

In FIG. 2, the second partial circuit H2 is fluidically coupled on the frame structure 5 to carry out a separating process, in which the adhesive connection between the frame structure 5 and the traction battery 3 is released. For this purpose, the circulating pump 21 and the heating unit 25 are activated to flood the fluid chambers 9 of the frame structure 5 using heated thermofluid 15. The thermofluid 15 can in this case have a temperature of, for example, 220° C. and can permeate the frame structure 5 over a process duration of, for example, one or two minutes. The process parameters in the separating process are designed so that the thermal energy introduced by the thermofluid 15 into the adhesive bond is sufficient to heat the adhesive 4 enough that a complete release of the adhesive connection occurs.

A further exemplary embodiment of the invention is shown in FIG. 4, which is fundamentally embodied structurally identical to the preceding exemplary embodiment. In contrast to FIG. 3, two fluid chambers 9 fluidically separated from one another are provided. The two fluid chambers each comprise a separate supply 17 and drain 19.

1-11. (canceled)

12. A releasable adhesive connection between two joint partners comprising:
the two joint partners are materially connected to one another by an adhesive, wherein the adhesive connection is releasable in a separating process by an introduction of heat, wherein the introduction of heat is performed using a heated thermofluid, and in that at least one first joint partner further comprises at least one fluid chamber, which is filled at least in the separating process using the thermofluid and which indirectly or directly adjoins the adhesive with a chamber wall, so that in the separating process, the introduction of heat into the adhesive takes place by heat conduction from the thermofluid via the chamber wall into the adhesive.

13. The releasable adhesive connection as claimed in claim 12, wherein the first joint partner is designed as a thermofluid-conducting component and/or is incorporated into a preferably closed heating circuit, and in that in particular in the heating circuit, the thermofluid is conducted via a supply connecting part into the fluid chamber of the first joint partner and/or is conducted via a return connecting part out of the fluid chamber of the first joint partner, specifically in particular with forced conduction by means of a flow unit, such as a circulating pump.

14. The releasable adhesive connection as claimed in claim 13, wherein a heating unit and a thermofluid reservoir are integrated into the heating circuit in addition to the flow unit and the fluid chamber of the first joint partner.

15. The releasable adhesive connection as claimed in claim 14, wherein the heating circuit is divided into a first partial circuit on the joint partner side and a second partial circuit, which can be decoupled from the first joint partner, and in that in particular the second partial circuit can be fluidically decoupled from the first joint partner at the supply and return connecting pieces.

16. The releasable adhesive connection as claimed in claim 15, wherein the second partial circuit, which can be decoupled from the first joint partner, comprises the flow unit, the heating unit, and the thermofluid reservoir.

17. The releasable adhesive connection as claimed in claim 14, wherein the flow unit, the heating unit, and possibly a supply and/or return temperature sensor are parts of a control loop, in which a regulating unit in the separating process activates the heating unit and/or the flow unit on the basis of the detected supply and/or return temperature.

18. The releasable adhesive connection as claimed in claim 17, wherein an input unit, by means of which a heating time and/or a heating temperature of the thermofluid can be predetermined, is associated with the regulating unit.

19. The releasable adhesive connection as claimed in claim 12, wherein the thermofluid is, for example, a mineral oil, and/or in that the adhesive is, for example, a polyurethane adhesive, in which after heating to, for example, 220° C. with a holding time of, for example, 10 seconds, a complete release of the adhesive connection occurs.

20. The releasable adhesive connection as claimed in claim 12, wherein the first joint partner is a multi-chamber extruded profile part and is in particular produced from a metal of high thermal conductivity, for example, a light metal such as an aluminum alloy.

21. The releasable adhesive connection as claimed claim 12, wherein the first joint partner is a frame structure of an electrically operated vehicle, which is constructed from longitudinal beams and crossbeams and which encloses a traction battery of the vehicle, and in that the longitudinal beams and/or crossbeams have a detachable adhesive connection to the traction battery with the inner walls thereof, and in that the longitudinal beams and/or crossbeams are permeated by the thermofluid in the separating process to remove the traction battery.

22. The releasable adhesive connection as claimed in claim 15, wherein the flow unit, the heating unit, and possibly a supply and/or return temperature sensor are parts of a control loop, in which a regulating unit in the separating process activates the heating unit and/or the flow unit on the basis of the detected supply and/or return temperature.

23. The releasable adhesive connection as claimed in claim 16, wherein the flow unit, the heating unit, and possibly a supply and/or return temperature sensor are parts of a control loop, in which a regulating unit in the separating process activates the heating unit and/or the flow unit on the basis of the detected supply and/or return temperature.

24. The releasable adhesive connection as claimed in claim 13, wherein the thermofluid is, for example, a mineral oil, and/or in that the adhesive is, for example, a polyurethane adhesive, in which after heating to, for example, 220° C. with a holding time of, for example, 10 seconds, a complete release of the adhesive connection occurs.

25. The releasable adhesive connection as claimed in claim 14, wherein the thermofluid is, for example, a mineral oil, and/or in that the adhesive is, for example, a polyurethane adhesive, in which after heating to, for example, 220° C. with a holding time of, for example, 10 seconds, a complete release of the adhesive connection occurs.

26. The releasable adhesive connection as claimed in claim 15, wherein the thermofluid is, for example, a mineral oil, and/or in that the adhesive is, for example, a polyurethane adhesive, in which after heating to, for example, 220° C. with a holding time of, for example, 10 seconds, a complete release of the adhesive connection occurs.

27. The releasable adhesive connection as claimed in claim 16, wherein the thermofluid is, for example, a mineral oil, and/or in that the adhesive is, for example, a polyurethane adhesive, in which after heating to, for example, 220° C. with a holding time of, for example, 10 seconds, a complete release of the adhesive connection occurs.

28. The releasable adhesive connection as claimed in claim 17, wherein the thermofluid is, for example, a mineral oil, and/or in that the adhesive is, for example, a polyurethane adhesive, in which after heating to, for example, 220° C. with a holding time of, for example, 10 seconds, a complete release of the adhesive connection occurs.

29. The releasable adhesive connection as claimed in claim 18, wherein the thermofluid is, for example, a mineral oil, and/or in that the adhesive is, for example, a polyurethane adhesive, in which after heating to, for example, 220° C. with a holding time of, for example, 10 seconds, a complete release of the adhesive connection occurs.

30. The releasable adhesive connection as claimed in claim 13, wherein the first joint partner is a multi-chamber extruded profile part and is in particular produced from a metal of high thermal conductivity, for example, a light metal such as an aluminum alloy.

31. The releasable adhesive connection as claimed in claim 14, wherein the first joint partner is a multi-chamber extruded profile part and is in particular produced from a metal of high thermal conductivity, for example, a light metal such as an aluminum alloy.
